(19) United States
(12) Patent Application Publication
(10) Pub. No.: US 2016/0314537 A1
(43) Pub. Date: Oct. 27, 2016

(54) System and Method of managing a supplemental program for a bonding company

(71) Applicant: Kelvin Hampton, Houston, TX (US)

(72) Inventor: Kelvin Hampton, Houston, TX (US)

(21) Appl. No.: 14/695,424

(22) Filed: Apr. 24, 2015

(51) Int. Cl. G06Q 40/08

(52) U.S. Cl. CPC G06Q 40/08

(57) ABSTRACT

The present invention discloses a system and method comprising stored instructions for managing operations of a supplemental pool insurance program for bail bonding companies. The system includes a server application that manages storage data devices that contain each bail bonding company profile information and supplemental pool insurance program information. The system further includes client devices in communication with a server application programs that manage each bail bonding company supplemental pool insurance.

This patent is a continuation of Ser. No. 14/554,091

### BACKGROUND

The system and method for managing operations of a bail bonding company.

A bail bond agent, is any person or business which acts as a surety by pledging money or property as bail for the appearance of a criminal defendant to court. Bail works by releasing a criminal defendant in exchange for money that the court holds until all proceedings and trials surrounding the accused person are complete. If a defendant fails to appear than the bonding company or agent have to pay the entire bond. Normally, the bonding company post a bond premium for a defendant in the range of 10% to 15% of the bond set by the court. The maximum bail amount is set by the state and the bail bonding company has the discretion to set the bail at an amount less than the maximum percentage set by the state. The prior art discloses several bail bond management systems as follows
a. U.S. Patent Application No. 2012/089498 describes systems, methods, and computer-readable media having stored instructions for managing operations of a bail bond company are disclosed.
b. U.S. Patent Application No. 2013/018675 describes a method, system and program storage device in a client/server environment comprises establishing a connection with the server for the purpose of obtaining at least one insurance policy.
c. U.S. Pat. No. 7,194,435 describes a method, system and apparatus for obtaining a bond is disclosed. The invention employs a computer system that has a work station in communication with a server to provide information on a contractor that is required by a surety over the computer system.
d. WO Patent No. 2008/076128 describes a bail bond issuing method according to an embodiment includes receiving a bond request for a defendant and receiving identifying information for the defendant.

What is disclosed is a new improved system that creates and manages a pool of money which acts as a supplemental insurance program for the bail company.

### SUMMARY

A single bond company may have multiple offices throughout a state or country. Each office manages client defendants for whom bonds have been posted. Bond contracts are generated for each prospective client. Once contract for a prospective client is completed, a bond premium is set and a pool amount is set for each contract and sent to the supplement insurance program.

In accordance with the one or more embodiment of the present invention, a system for managing the operation of a supplemental insurance program is disclosed. Client devices are configured to communication with the server devices that manage and create the insurance pool for multiple bonding companies.

In accordance with one or more embodiment of the present invention, a system and method for managing the operation of a supplemental insurance program is disclosed. The method comprises receiving identifying information for prospective clients, creating a bonding contract for prospective clients, determining an insurance pool for each prospective client, creating a supplemental insurance program based upon aggregate insurance pool of all prospective clients and managing the supplemental insurance program.

### DESCRIPTION OF DRAWINGS

FIG. 1 is a block diagram of the system configuration of the present invention.

FIG. 2 is a block diagram of the company application.

FIG. 2A is the flow chart of the bonding application.

FIG. 3 is a block diagram of the bonding server application.

FIG. 4 is a flow chart of the local bonding application.

FIG. 5 is a flow chart of the supplemental pool application.

FIG. 6 is a block diagram of the court summary information from the local court system.

FIG. 6A is a block diagram of the report generation process.

FIG. 7 is an illustration of the local court system detail transaction information display.

FIG. 8 is an illustration of the local court system court setting information display.

### DETAILED DESCRIPTION

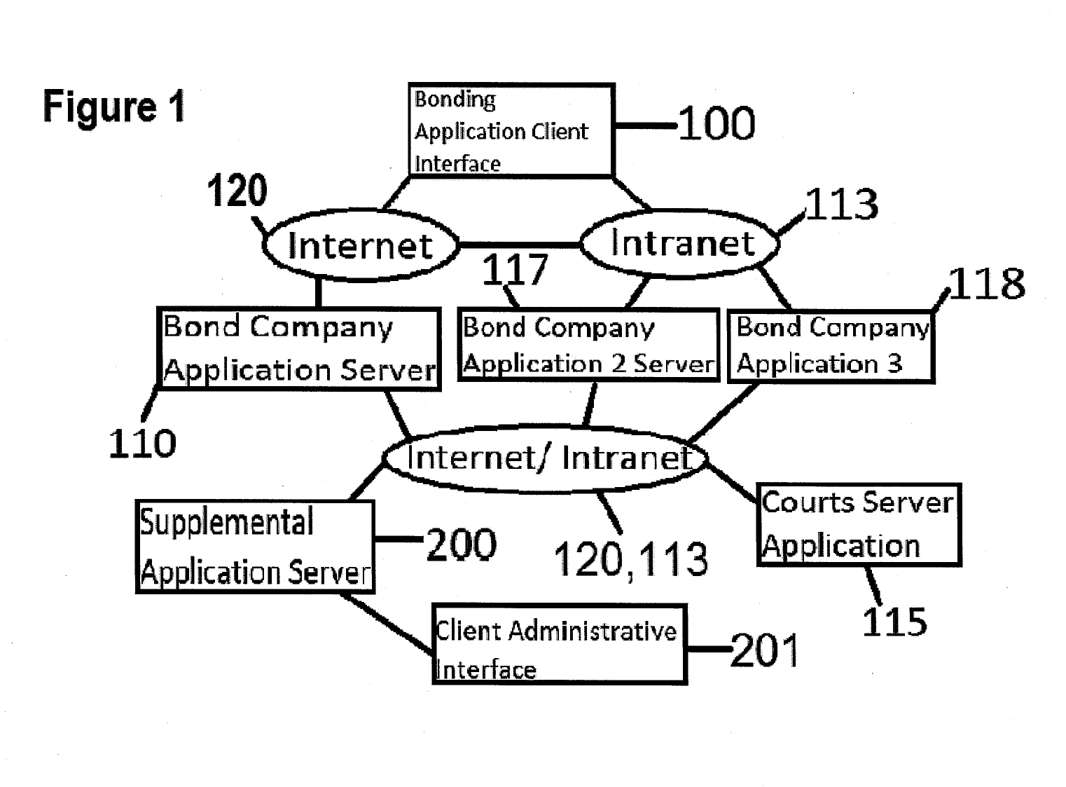

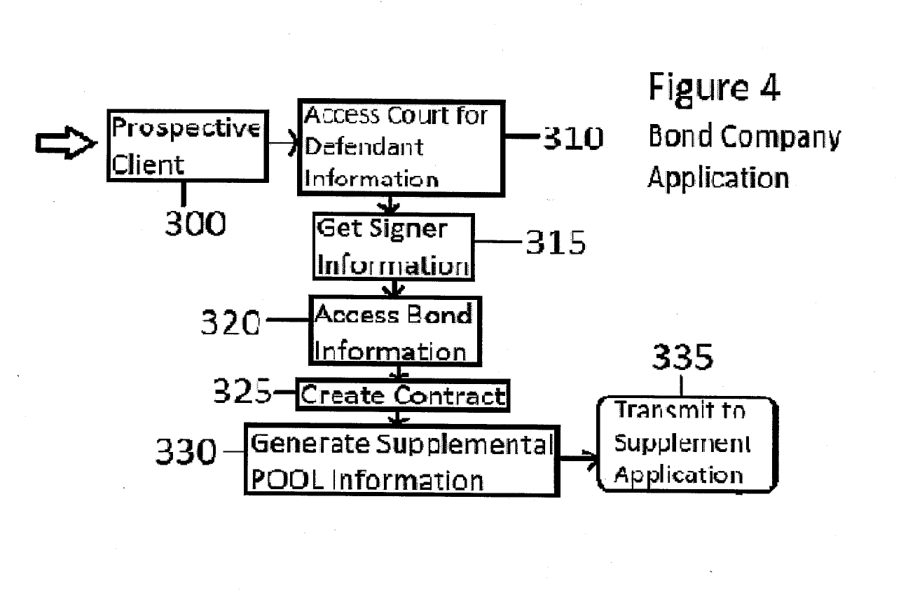

Referring to FIG. 1, there is shown an overview of the system configuration to support the system and method of the present invention, supplemental insurance pool system. This system manages and collects a supplemental insurance program for multiple bail bonding companies (110, 117, 118). As shown the supplemental server application (200) interfaces with multiple bail bonding server applications (100) through an intranet (113) or internet (120) to receive the bond contract information on each prospective client as shown in FIG. 4.

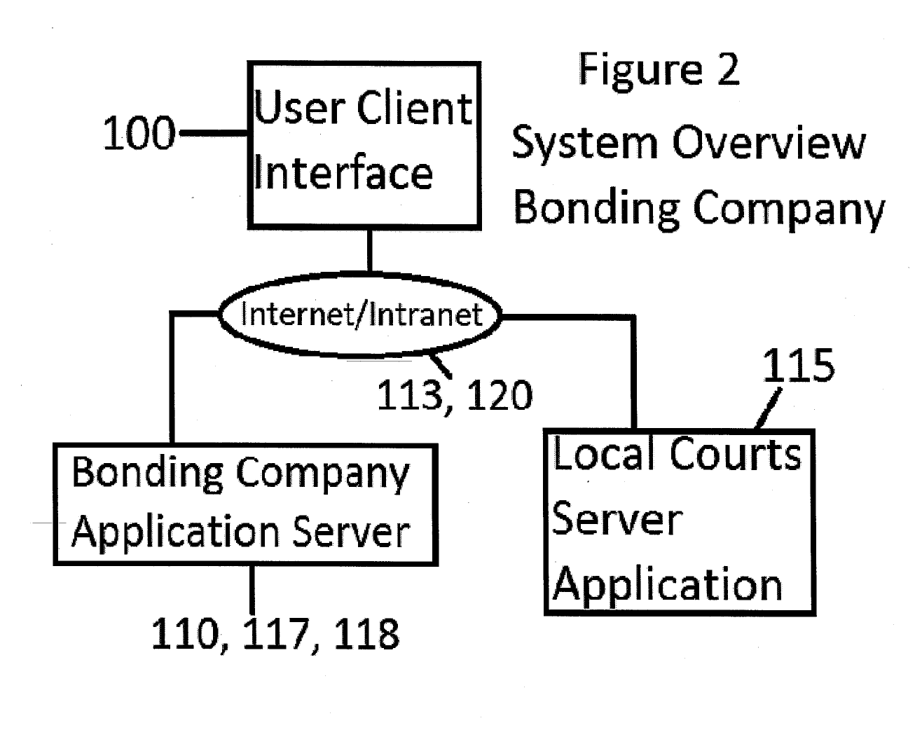

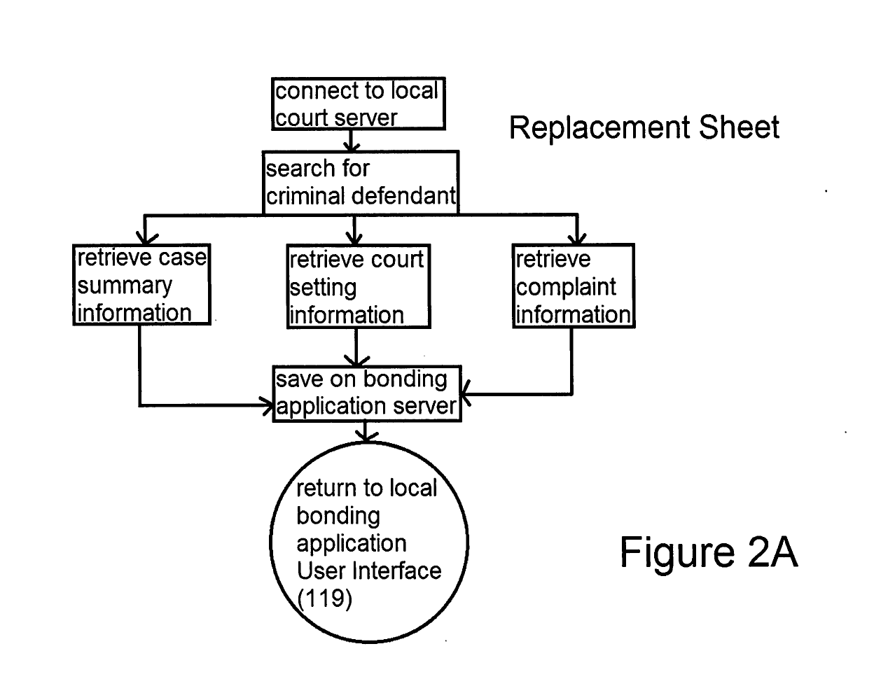

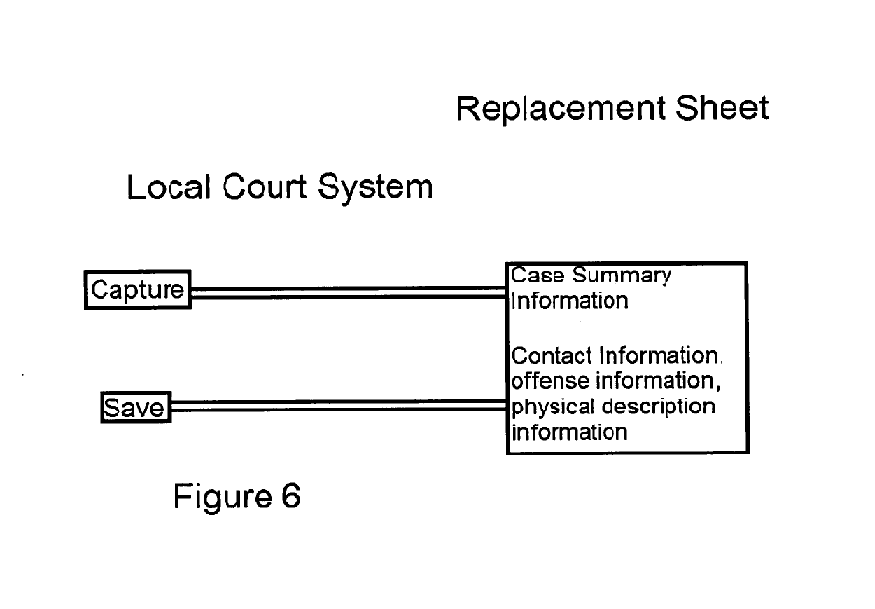

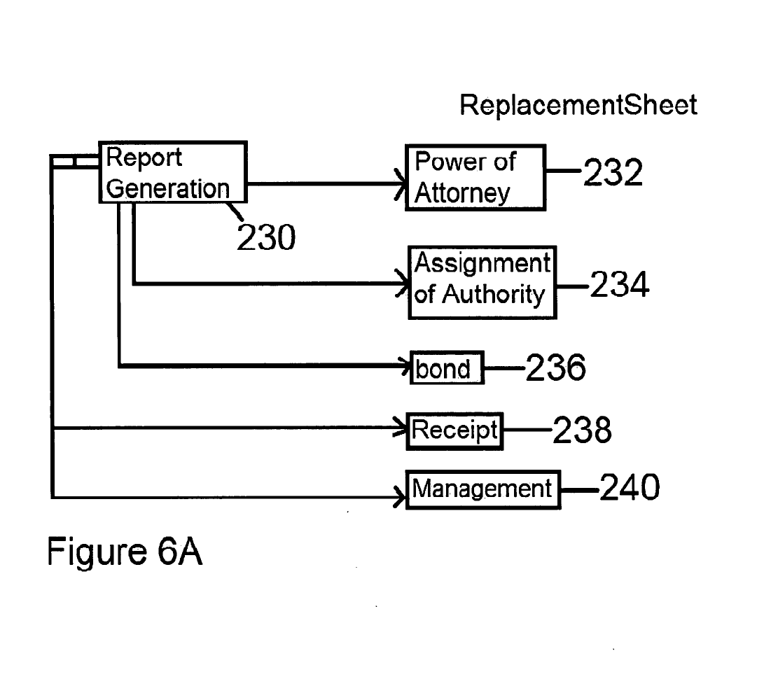

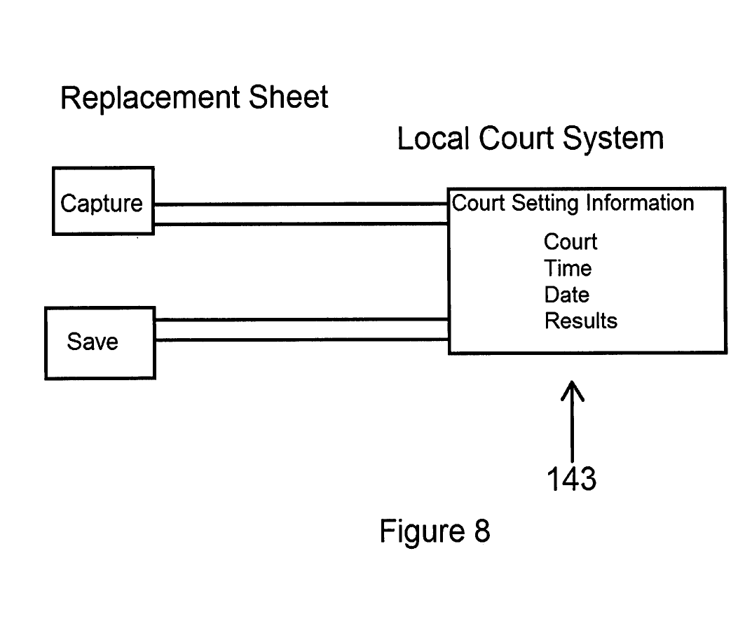

As depicted in FIG. 2, The bonding client application (100), via the internet or intranet (120, 113), provides the interface to the local bonding server application (110, 117, 118) and the local courts server application (115). As shown in FIG. 4, in this system a prospective client contacts (300) a bonding company to create a bond contract for a defendant. Local bonding server application (110) provides the services to manage the documentation generation to generate the bail bond contract for a prospective client as shown in FIG. 6A. Local courts server application (115) is interfaced to retrieve the required court setting information (143) depicted in FIG. 8 to support the documentation generation in FIG. 6A

of the present invention for a criminal defendant.

Referring to FIG. 2, there is shown an overview of the bonding application supported within a conventional client/server environment via the internet. Client Application (100) utilizing conventional Internet Protocols allows the user to initiate a local user interface (100) or the web user interface (117). Local interface (100 or 117) connects with the bonding server application (110) which allows the user to manually input the information to support the generation of the documents. Web interface (117) allows the user to connect to the local court system server (115) and to automatically capture the criminal defendant information and transfer this information to the bonding application server (110) database structure. Bonding server application (110) on or implemented with an integrated system structure supported by a plurality of database tables and queries to support the services outlined in FIG. 4 and the documentation generation services outlined in FIG. 6A. Upon completion of the transfer of information through web interface (117 or 119) to bonding server application (110), the user can then automatically generate the documents outlined in FIG. 6A. This feature offers the full advantage of saving time and money in managing the bonding process.

As shown in FIG. 4, after a prospective client (300) contacts the bail bonding company, the system access the court local server to obtain the defendant information in step 310. In step 315, the system stores the prospective client or signer information. In step 320 the system obtain surety bond information to support a defendant contract. At step 325, the contract is created. after the documentation is generated for the bail bond contract in step 325, the system creates a supplemental 330 pool for a defendant.

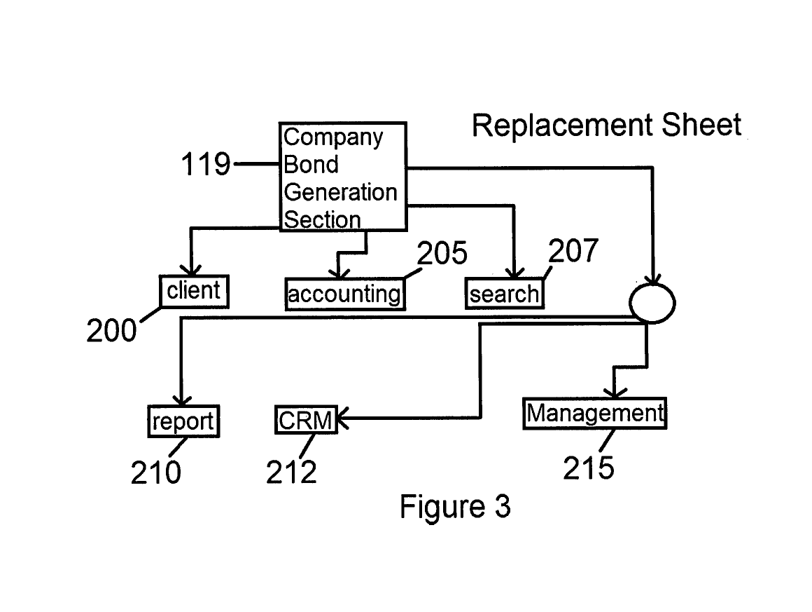

To support the bail bonding in step 330, document generation and a database structure is created containing the client information, the defendant information, case specific information and the pool information which is sent to the supplemental application in step 335. Referring to FIG. 4, there is shown a block diagram of the bonding server local application (110) depicted in FIG. 1. The bonding local application interface (119) provides access to the following services as shown in FIG. 3:

Client module 200 manages the Defendant information;

Accounting module 205 tracks and manages payments by the co-signer of the bond; and allows for the co-signer information to be inputted into the system;

Search module 207 allows a user to retrieve a criminal defendant information from the system;

Report module 210 generates the documentation to support the bonding process;

CRM module 212 manages the co-signer information; and

Management module 215 provides the administration of the system.

Referring to FIG. 6, one of the most important features of the system, the documentation generation process is depicted therein (350). After information is saved into the database structure as described in the system it generates the documents outlined in FIG. 6A. This feature allows the generation of the documentation supporting the bonding process to be completed within a few minutes.

To support the generation of each document a specific database query is created. Upon the selection of the specific document to generate, the information to support the query is retrieved from the database and displayed on the computer screen. Then, the generated document can be printed.

The Client specific documents as shown in FIG. 6A are:
Power report 232 which generates documentation that allows the insurance surety of the bonding agent to file the bond;
Assignment report 234 which generates documents which allow the co-signer to turn in the bond;
Bond 236 report which generates the actual bond paper work; and
Receipt report 238 which generates payment receipts for the co-signer.

Additionally, the system supports the generation of general management documentation 240, for example:
Generation of billing statements;
Generation of collection notices;
Generation of defendants court appearances; and
Generation of bond forfeitures by defendants.

As depicted in FIG. 2, to automatically capture the criminal defendant information from a specific local court system, a user utilizing the Web User interface (117) would connect to local court system server (115) via the internet using conventional protocols. After the system connects to the local court server application at step 130), the system allows the user to perform the following functions as depicted in FIG. 2A:

At step 135, the system searches for the correct defendant on the local server application using conventional protocols;

At step 143, the system retrieves the web page for the defendant's case summary information (350) as shown in FIG. 6, from the local server application using conventional protocols;

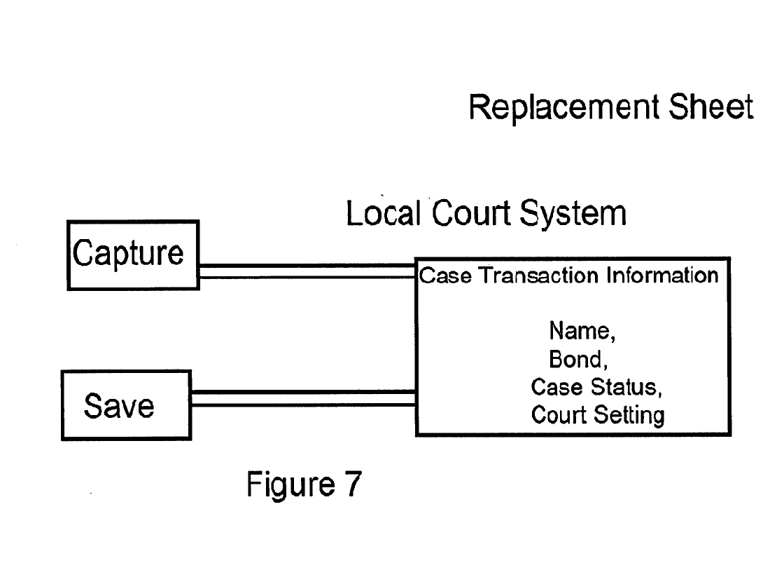

Then, at step 137, the system captures from the defendant's detail offense information web page (141), the pertinent information to store in the database in FIG. 7

At step 140, the system retrieves the web page for the defendant's detail offense information (141) as shown in FIG. 7, from the local server application using conventional protocols;

Then, capture from the defendant's case summary web page, the pertinent information to store in the database;

At step 142, the system retrieves the web page for the defendant's court setting information (143) as shown in FIG. 8, from the local server application using conventional protocols;

Then, capture from the defendant's court setting information (143) in FIG. 8 web page, the pertinent information to store in the database; and

At step, 145, store into the database the retrieved case summary information (350), the detail offense information (141) and the court setting information (141). At step 147, return to local user interface when complete.

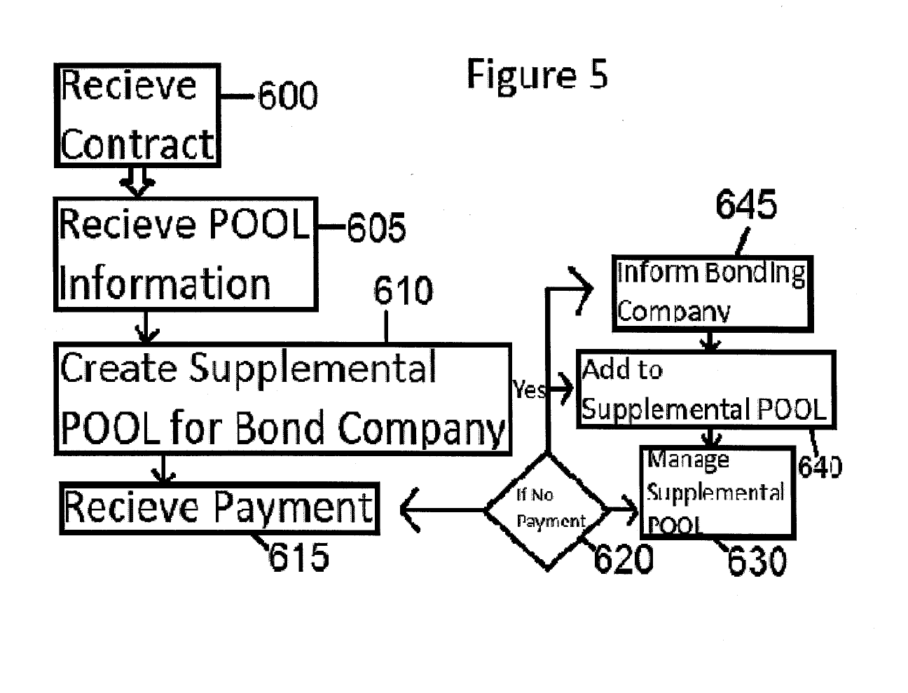

Referring to FIG. 5 there is shown a flow chart of the supplemental program. At step 600, the system transmits the bond contract information to the supplemental module. At step 605, the system transmits the pool information for a defendant to the supplemental program server application for a specific bonding company. In step 610, from the contract and pool information for a defendant, the system determines the maximum amount of bond for a defendant based upon the state requirements. The bond insurance pool amount for a specific contract is determined based upon the state maximum bond amount minus the specific bond contract amount set by the bond company. In step 615, the supplemental program contacts the financial institution and setup a payment calendar for a specific bond contract pool. In step 645, if the pool amount on a specific bond contract cannot be collected at step 620 then, the bonding company is contacted to make alternative payment arrangements. In step 640, if pool amount is collected, the amount is placed within the supplemental pool for a specific bond company. A bonding company insurance total insurance pool is managed by the system based upon the aggregate of all the bonding contracts for a specific bail bond company. In step 630, the supplemental program manages each bail bonding company.

What is claimed is:

1. A system for managing operations of a supplemental program for one or more Bail Bond Companies implemented on one or more server devices, the system comprising:
one or more data storage devices installed on the one or more server devices;
a defendant module that comprises one or more defendant bond transaction profiles,
an insurance pool administration module in electronic communication with the defendant module,
the insurance pool administration module including one or more managing sub-modules to generate a bail bond pool amount based upon a maximum state bond requirement minus the bond contract amount of the one or more bail bond companies;
and a management pool module for generating an insurance pool for each bail bond company by aggregating the bail bond pool amount for each bail bond company; and
one or more client devices that communicate with one or more data storage devices on server devices for storage of the defendant bond transaction profiles with the corresponding insurance pool

2. A method for managing operations of a supplemental insurance program executing on a server device for one or more bail bond companies, the method comprising:
a. establishing an electronic communication link between the the bail bond company and the supplemental insurance program stored on the server device;
b. receiving each defendant bond transaction information from the one or more bail bond companies through the electronic communication link For each defendant bond transaction information from the one or more bail bond companies, generating a a maximum pool amount based upon a maximum bond amount set by a state requirement.
c. For each defendant bond transaction information from the one or more bail bond companies, generating a pool contract amount by subtracting each defendant bond transaction from the maximum pool amount;
d. For the one or more bail bond companies managing an insurance pool information profile by aggregating each pool contract amount for a specific bail bond company and storing the bond transaction amount, the pool amount and the insurance pool information profile on one or more storage devices on the one or more storage devices.

3. A system for managing operations of a supplemental program for a Bail Bond Company;
a non-transitory computer-readable medium storing a computer program including instructions for managing operations of the supplemental program of a bail bond company, the instructions comprising:
a. establishing an electronic communication link between the the bail bond company and the supplemental insurance program stored on the server device;.
b. receiving each defendant bond transaction information from the one or more bail bond companies through the electronic communication link For each defendant bond transaction information from the one or more bail bond companies, generating a a maximum pool amount based upon a maximum bond amount set by a state requirement.
c. For each defendant bond transaction information from the one or more bail bond companies, generating a pool contract amount by subtracting each defendant bond transaction from the maximum pool amount; and
d. For the one or more bail bond companies managing an insurance pool information profile by aggregating each pool contract amount for a specific bail bond company and storing the bond transaction amount, the pool amount and the insurance pool information profile on one or more storage devices on the one or more storage devices.
